(19) United States
(12) Patent Application Publication
(10) Pub. No.: US 2026/0038383 A1
(43) Pub. Date: Feb. 5, 2026

(54) INTERACTION ANALYSIS METHOD AND RELATED CHATBOT SYSTEM

(71) Applicant: ViewSonic International Corporation, New Taipei City (TW)

(72) Inventors: Hsin-Yu Lin, New Taipei City (TW); Yu-Ming Lu, New Taipei City (TW)

(73) Assignee: ViewSonic International Corporation, New Taipei City (TW)

(21) Appl. No.: 18/902,840

(22) Filed: Sep. 30, 2024

(30) Foreign Application Priority Data
Aug. 5, 2024 (TW) 113129183

(51) Int. Cl. G09B 5/12

(52) U.S. Cl. CPC G09B 5/12

(57) ABSTRACT

An interaction analysis method, for a Chatbot system, includes requesting, by a first user, the Chatbot system to propose at least one exam question for at least one second user; respectively responding, by the at least one second user, the at least one response to the at least one exam question; determining, by the Chatbot system, an interaction level for the at least one response of the at least one second user; and summarizing, by the Chatbot system, a current learning status of each of the at least one second user based on the interaction level.

### BACKGROUND OF THE INVENTION

### 1. Field of the Invention

The present invention relates to an interaction analysis method and a related Chatbot system, more particularly, to an interaction analysis method and the related Chatbot system capable of improving interactivity system.

### 2. Description of the Prior Art

Conventional remote learning or online learning provides unidirectional experiences, e.g., a lecture or teaching is delivered by a lecturer or a teacher, the audiences or the students can only be receivers of the delivered information or course content. Because of this, targeting a specific student or an unspecified group of students and then ask questions will take a lot of time.

The conventional remote learning or online learning provides an interaction method between the users and a Chatbot. However, the conventional Chatbot can only reply robotically. The lecturer or the teacher needs to explain each answer again respectively, which cannot lighten the burden of the lecturer or teacher.

Therefore, improvements are necessary to the interactivity of the conventional online Chatbot.

### SUMMARY OF THE INVENTION

In light of this, the present invention provides an interaction analysis method and related Chatbot system to improve the interactivity between the Chatbot and users.

An embodiment of the present invention discloses an interaction analysis method, for a Chatbot system, comprises requesting, by a first user, the Chatbot system to propose at least one exam question for at least one second user; respectively responding, by the at least one second user, the at least one response to the at least one exam question; determining, by the Chatbot system, an interaction level for the at least one response of the at least one second user; and summarizing, by the Chatbot system, a current learning status of each of the at least one second user based on the interaction level.

Another embodiment of the present invention discloses a Chatbot system, comprises a database for data storage; and a processing unit, configured to execute an interaction analysis method, wherein the interaction analysis method includes requesting, by a first user, the Chatbot system to propose at least one exam question for at least one second user; respectively responding, by the at least one second user, the at least one response to the at least one exam question; performing, by the Chatbot system, an interaction level for the at least one response of the at least one second user; and determining, by the Chatbot system, a current learning status of each of the at least one second user based on the interaction level.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a Chatbot system according to an embodiment of the present invention.

FIG. 2 is a schematic diagram of an interaction analysis method according to an embodiment of the present invention.

FIG. 3 is a schematic diagram of an exam question generation method according to an embodiment of the present invention.

FIG. 4 is a schematic diagram of interactions between a teacher, students and the Chatbot system according to an embodiment of the present invention.

FIG. 5 is a schematic diagram of an interaction analysis method according to an embodiment of the present invention.

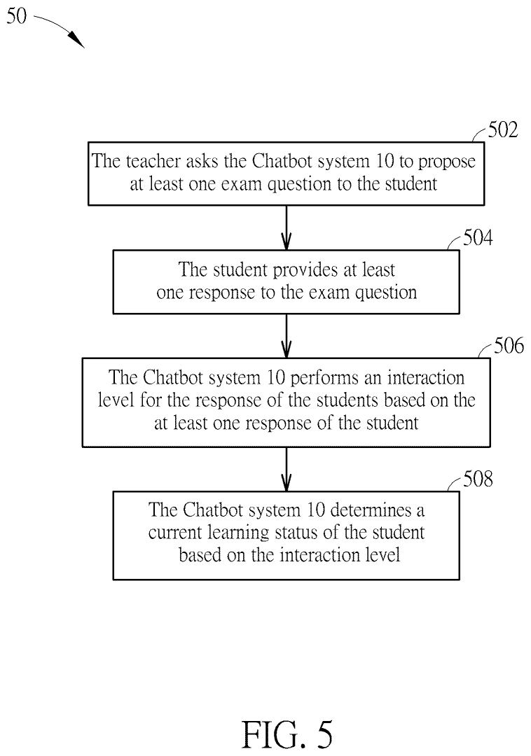

FIG. 6 is a schematic diagram of a usage scenario according to an embodiment of the present invention.

### DETAILED DESCRIPTION

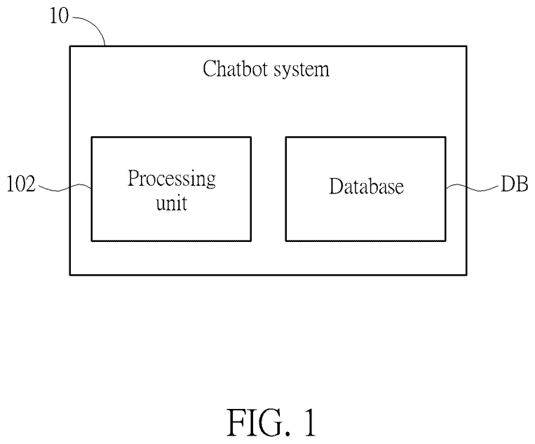

Please refer to FIG. 1, which is a schematic diagram of a Chatbot system 10 according to an embodiment of the present invention. The Chatbot system 10 includes a database DB and a processing unit 102. The Chatbot system 10 may be an artificial intelligence (AI) Chatbot. The database DB is utilized for storing data for the Chatbot system 10, the processing unit 102 is configured to execute an interaction analysis method and respond to the user based on the messages inputted by a user.

The Chatbot system 10 based on an embodiment of the present invention may be utilized in an online classroom to interact with remote or online users. More specifically, the Chatbot system 10 may be a learning medium between teachers and students before the class, in the class, or after the class. For example, when the teacher is giving a course related to the solar system, the Chatbot system 10 may be assigned by the teacher to send exam questions in the online classroom to determine the understanding level of the students. Alternatively, the Chatbot system 10 may receive questions or homework from the teacher after the class. The Chatbot system 10 can assist the students to answer the questions or finish the homework based on the response of the students.

Therefore, the students may receive messages from the Chatbot system 10 online and have conversations with the Chatbot system 10 about the solar system. In this way, the Chatbot system 10 may collect the responses from the students, summarize the responses in the online classroom or from the remote students, and provide the summary to the teacher, such that the teacher may obtain learning status of each or specific student accordingly.

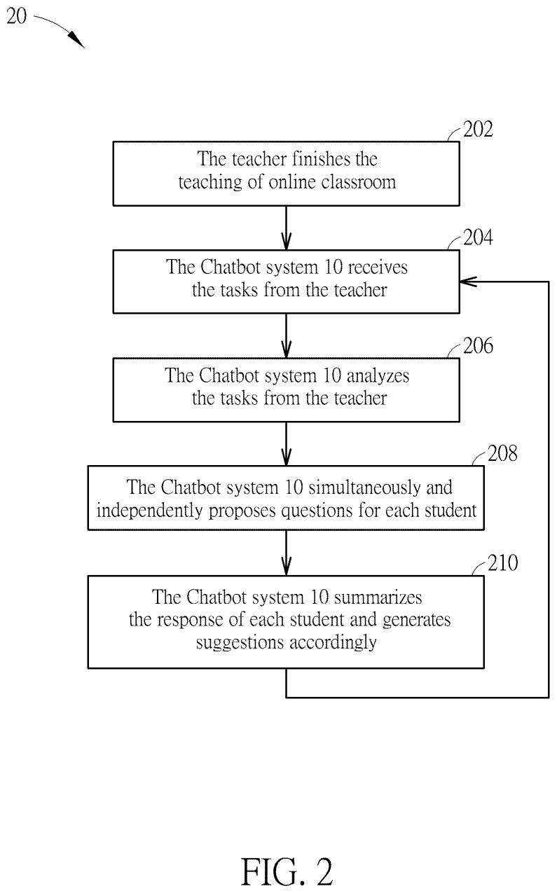

Please refer to FIG. 2, which is a schematic diagram of an interaction analysis method 20 according to an embodiment of the present invention. The interaction analysis method 20 includes the following steps:
Step 202: The teacher finishes the teaching of online classroom;
Step 204: The Chatbot system 10 receives the tasks from the teacher;
Step 206: The Chatbot system 10 analyzes the tasks from the teacher;
Step 208: The Chatbot system 10 simultaneously and independently proposes questions for each student;
Step 210: The Chatbot system 10 summarizes the response of each student and generates suggestions accordingly.

In detail, after the teacher finished the teaching in the online classroom in step 202, the teacher may upload teaching material, e.g., a graphic file, a PDF file or other types of file, and education standards corresponding to the teaching content, e.g., the education standards are determined based on different grade of students in different countries, to the Chatbot system 10 in step 204. In addition, the teacher can assign the Chatbot system 10 to generate different exam questions for different students based on the teaching material given by the teacher, the related education standards, and the understanding level of each student.

In step 206, the processing unit 102 of the Chatbot system 10 may analyze the tasks from the teacher. For example, the Chatbot system 10 may compare the education standards with the teaching content to extract at least one learning objective. For another example, the Chatbot system 10 may determine the learning objective of each paragraph of teaching content taught by the teacher related to the education standards corresponding to each paragraph of the teaching content.

In step 208, the processing unit 102 of the Chatbot system 10 may simultaneously and independently propose questions for each student, i.e., the processing unit 102 of the Chatbot system 10 may generate at least one exam question related to the at least one learning objective, which is based on the teaching contents and the education standards. For instance, the processing unit 102 of the Chatbot system 10 may respectively propose a related exam question based on the learning objective corresponding to the teaching content of the teacher. In addition, the processing unit 102 of the Chatbot system 10 may determine corresponding exam questions based on the learning objective and a current learning status of the student in the class, wherein the current learning status is determined based on an interactive performance of the student in the class.

In an embodiment, when the data provided by the teacher are homework questions, the processing unit 102 of the Chatbot system 10 may individually recognize at least one exam question of the homework questions based on the at least one learning objective to confirm that the exam questions are related to the homework questions provided by the teacher and the education standards. As such, the Chatbot system 10 may assist the student or give suggestions to the student when the student answers the questions.

In step 210, the Chatbot system 10 may summarize the responses of the student and generate suggestions corresponding to each of the students to the teacher. That is, the Chatbot system 10 may determine a corresponding learning feedback based on the learning status of the student and corresponding response, such that the teacher may rapidly and effectively determine how to assist the students based on the learning feedback of each student provided by the Chatbot system 10.

Notably, in an embodiment, the suggestions for each student determined in step 210 and the tasks provided by the teacher in step 204 may be the basis for the analysis of the Chatbot system 10.

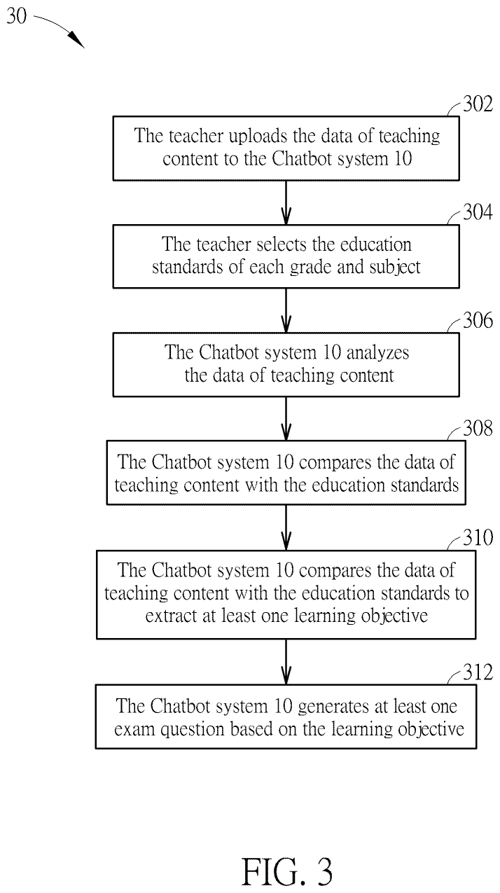

After the data of teaching content is provided by the teacher to the processing unit 102 of the Chatbot system 10 and the education standards corresponding to the teaching content is determined, a flowchart of generating corresponding exam questions by the Chatbot system 10 may be concluded as an exam question generation method 30, please refer to FIG. 3.
Step 302: The teacher uploads the data of teaching content to the Chatbot system 10;
Step 304: The teacher selects the education standards of each grade and subject;
Step 306: The Chatbot system 10 analyzes the data of teaching content;
Step 308: The Chatbot system 10 compares the data of teaching content with the education standards;
Step 310: The Chatbot system 10 compares the data of teaching content with the education standards to extract at least one learning objective;
Step 312: The Chatbot system 10 generates at least one exam question based on the learning objective.

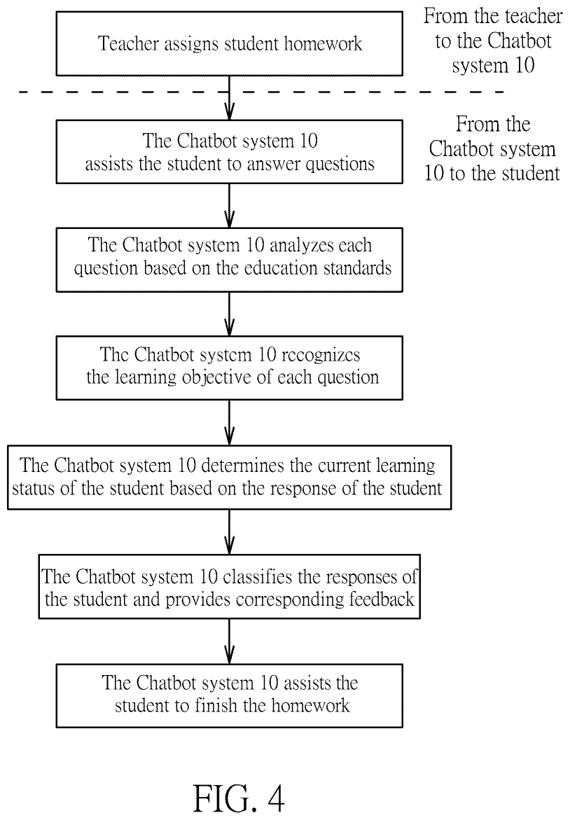

In an embodiment, interactions between the teacher, the students and the Chatbot system 10 may be summarized in FIG. 4. In the embodiment of FIG. 4, “Teacher assigns student homework” denotes that after the teacher uploads the data of the teaching content to the Chatbot system 10 and selects corresponding education standards, the Chatbot system 10 is indicated to assist the students based on the response of the students.

On the other hand, the interactions between the Chatbot system 10 and the student are: “the Chatbot system 10 assists the student to answer questions”, “the Chatbot system 10 analyzes each question based on the education standards”, “the Chatbot system 10 recognizes the learning objective of each question”. Thus, “the Chatbot system 10 determines the current learning status of the student based on the response of the student” and “the Chatbot system 10 classifies the responses of the student and provides corresponding feedback”. Then, “the Chatbot system 10 assists the student to finish the homework”.

An interaction analysis method 50 of the response of the student may be concluded based on the response of the student. The interaction analysis method 50 includes the following steps:
Step 502: The teacher asks the Chatbot system 10 to propose at least one exam question to the student;
Step 504: The student provides at least one response to the exam question;
Step 506: The Chatbot system 10 performs an interaction level for the response of the students based on the at least one response of the student;
Step 508: The Chatbot system 10 determines a current learning status of the student based on the interaction level.

In detail, different to the interaction analysis method 20, in step 502 of interaction analysis method 50, the teacher asks the Chatbot system 10 to propose at least one exam question to the student. In step 504, the student makes responses to the exam question. The Chatbot system 10 determines the interaction level for the response of the student accordingly, e.g., the interaction level is analyzed based on Bloom's Taxonomy in step 506. Therefore, the Chatbot system 10 may determine the current learning status of the student based on the interaction level.

In an embodiment, Bloom's Taxonomy includes a Remember level, an Understand level, an Apply level, an Analysis level, an Evaluate level and a Create level.

In a normal scenario, the Chatbot system 10 may probabilistically give a praise when the student consecutively solves the questions, or randomly give a praise when the student solves the questions.

In another scenario, when the student cannot answer the question, or does not answer the question, the Chatbot system 10 may probabilistically encourage the student based on a number of unanswered questions, and narrate the importance of the question based on the learning objective to increase the probability of response of the student.

Or, when the Chatbot system 10 cannot teach the question, what the student replies, the Chatbot system 10 narrates the importance of the question and encourages the student with guided narrations.

On the other hand, the Chatbot system 10 may perform the interaction analysis with the student based on Bloom's Taxonomy. More specifically, the Remember level denotes basic concepts of memory, which defines, describes, recalls and recognizes the learning content; the Understand level is to compare, discuss, explain and predict the learning content; the Apply level is to determine, discover, express and predict the learning content; the Analysis level to compare, identify, investigate and relate the learning content; the Evaluate level is to conclude, interpret, support and validate the learning content; the Create level is to develop, formulate, incorporate and summarize the learning content.

Since the interaction analysis between the student and the Chatbot system 10 is determined based on Bloom's Taxonomy, the Chatbot system 10 may propose corresponding inspiring or guiding narration based on the response of the student. Meanwhile, the Chatbot system 10 may determine the current learning status of the student based on the response of the student and provide the result to the teacher. For example, when the Chatbot system 10 classifies the interaction into the Remember level of Bloom's Taxonomy, the Chatbot system 10 may generate comforting narration when the response of the student implies frustration, and ask related background acknowledgments for associative learning.

In addition, the Chatbot system 10 may determine a learning feedback of the student based on the current learning status of the student, and then provide the current learning status of the student to the teacher. In this way, the teacher may adjust teaching materials for different students based on the classification result and the learning feedback corresponding to each student, i.e., the teacher may adjust the difficulty of the teaching material based on the learning status of a student.

In an embodiment, the task provided by the teacher and the learning status of each student may be provided to step 206 of the interaction analysis method 20 for analysis, such that the Chatbot system 10 may optimize the exam question proposed for each student. That is, through the learning status of each student, the Chatbot system 10 may increase an accuracy of a determination of the understanding level of the students based on the interaction analysis corresponding to the students. In this way, the teacher may adjust the teaching materials based on the interactive performance of the students.

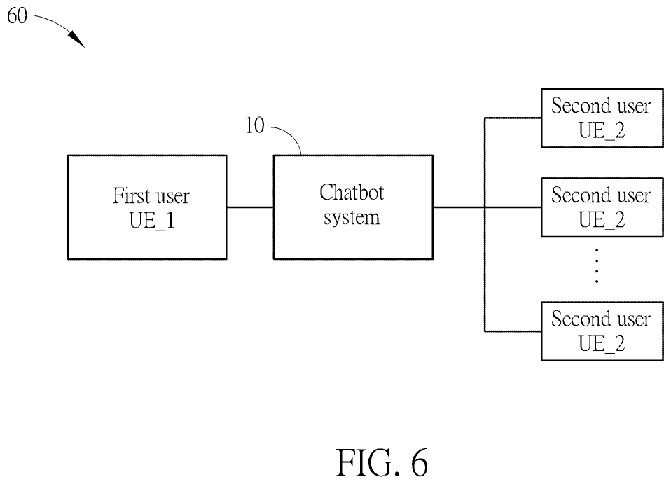

Please refer to FIG. 6, which is a schematic diagram of a usage scenario 60 according to an embodiment of the present invention. The usage scenario 60 includes the Chatbot system 10, a first user UE 1 and a plurality of second user UE 2, wherein the first user UE 1 may be a teacher or a lecturer, the second user UE 2 may be a student or an audience. Notably, a number of the first user UE 1 and the second user UE 2 are not limited to the embodiment of FIG. 6, other numbers of the first user UE 1 and the second user UE 2 are applicable to the present invention.

In addition, the Chatbot system 10 may further include a cloud server, a third-party application programming interface (API) and related cloud devices, and is not limited thereto.

Therefore, the Chatbot system 10 may be a medium layer between the teacher and the students online. With the analysis of the Chatbot system 10 based on the teaching content, the education standards, and the interaction analysis of the students, the teacher may obtain the learning feedback of the students more precisely and effectively to improve the quality of future teaching and lecturing.

Notably, the embodiments of the present invention illustrated above may be properly modified by people skilled in the art based on the requirements of users or related computer systems, and are not limited to the above examples, which are within the scope of the present invention.

In summary, the present invention provides an interaction analysis method and related Chatbot system to improve the interactivity between the Chatbot and users to increase a learning result of students.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An interaction analysis method, for a Chatbot system, comprising:
requesting, by a first user, the Chatbot system to propose at least one exam question for at least one second user;
respectively responding, by the at least one second user, the at least one response to the at least one exam question;
determining, by the Chatbot system, an interaction level for the at least one response of the at least one second user; and
summarizing, by the Chatbot system, a current learning status of each of the at least one second user based on the interaction level.

2. The interaction analysis method of claim 1, wherein the interaction level is performed based on Bloom's Taxonomy.

3. The interaction analysis method of claim 2, wherein the interaction level includes a Remember level, an Understand level, an Apply level, an Analysis level, an Evaluate level and a Create level.

4. The interaction analysis method of claim 1, wherein the current learning status is determined based on an interaction performance between the second user and the Chatbot system.

5. The interaction analysis method of claim 4, wherein the Chatbot system is configured to determine a learning feedback of the second user is determined based on the current learning status of the second user.

6. The interaction analysis method of claim 5, wherein a teaching material for the second user is adjusted by the first user based on the learning feedback of the second user.

7. The interaction analysis method of claim 1, further comprising:
the Chatbot system takes corresponding responds based on the interaction level.

8. A Chatbot system, comprising:
a database for data storage; and
a processing unit, configured to execute an interaction analysis method, wherein the interaction analysis method including:
requesting, by a first user, the Chatbot system to propose at least one exam question for at least one second user;
respectively responding, by the at least one second user, the at least one response to the at least one exam question;
performing, by the Chatbot system, an interaction level for the at least one response of the at least one second user; and
determining, by the Chatbot system, a current learning status of each of the at least one second user based on the interaction level.

9. The Chatbot system of claim 8, wherein the interaction level is performed based on Bloom's Taxonomy.

10. The Chatbot system of claim 9, wherein the interaction level includes a Remember level, an Understand level, an Apply level, an Analysis level, an Evaluate level and a Create level.

11. The Chatbot system of claim 8, wherein the current learning status is determined based on an interaction performance between the second user and the Chatbot system.

12. The Chatbot system of claim 11, wherein a learning feedback of the second user is determined based on the current learning status of the second user.

13. The Chatbot system of claim 12, wherein a teaching material for the second user is adjusted by the first user based on the learning feedback of the second user.

14. The Chatbot system of claim 8, wherein interaction analysis method including:
the Chatbot system takes corresponding responds based on the interaction level.
